(19) United States
(12) Patent Application Publication
(10) Pub. No.: US 2013/0314322 A1
(43) Pub. Date: Nov. 28, 2013

(54) TOUCH PANEL AND INPUT SWITCHING METHOD

(71) Applicants: YU-TAI LIU, Tu-Cheng (TW); CHI-SHENG LIN, Tu-Cheng (TW); MING-CHANG KUO, Tu-Cheng (TW); MAO-HSIANG YEH, Tu-Cheng (TW)

(72) Inventors: YU-TAI LIU, Tu-Cheng (TW); CHI-SHENG LIN, Tu-Cheng (TW); MING-CHANG KUO, Tu-Cheng (TW); MAO-HSIANG YEH, Tu-Cheng (TW)

(73) Assignee: HON HAI PRECISION INDUSTRY CO., LTD., Tu-Cheng (TW)

(21) Appl. No.: 13/563,762

(22) Filed: Aug. 1, 2012

(30) Foreign Application Priority Data
May 22, 2012 (TW) 101118093

(51) Int. Cl. G06F 3/041; G06F 3/02

(52) U.S. Cl. 345/168

(57) ABSTRACT

A touch panel includes a transparent sheet with a keyboard layout pattern formed thereon, a touch display panel, a processor and at least two input modules. The input modules are chosen from the group consisting of a keyboard input module, a handwriting input module and a touch input module. The processor includes a touch operation recognition module, a determining module and a switching module. The touch operation recognition module identifies touch pattern on the touch panel. The determining module compares the touch pattern identified by the touch operation recognition module to preset touch pattern(s) and generates commands according to the comparison result. The switching module receives the command from the determining module and actives a corresponding input module.

### BACKGROUND

1. Technical Field

The present disclosure relates to a touch panel and, particularly, to a touch panel with touch keyboard pattern and input switching method of the touch panel.

2. Description of Related Art

Portable electronic devices are very popular; there is a trend towards miniaturization, so it is necessary to make portable electronic devices increasingly thinner than the traditional electronic devices. Take the traditional notebook computer for example; the keyboard is usually a pressing type, which includes some mechanical keys and a touch board under keys. The keyboard of this structure need reserve some space for the pressing trip of keys. Therefore, the keyboard wastes space goes against the trend towards miniaturization. And there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a partial isometric view of an exemplary embodiment of a touch panel.

FIG. 2 is a partial isometric view of backlight layer of FIG. 1.

FIG. 3 is a function module view of an exemplary embodiment of a touch panel.

FIG. 4 is a flowchart of input switching method applied in a touch panel according to a first exemplary embodiment of the present invention.

FIG. 5 is a flowchart of input switching method applied in a touch panel according to a second exemplary embodiment of the present invention.

### DETAILED DESCRIPTION

The present disclosure provides a touch panel with touch keyboard pattern. The touch panel 100 includes a touch panel and a transparent sheet with a keyboard layout pattern formed thereon. The touch panel is generally thinner than a conventional pressing type keyboard. The touch panel with touch keyboard pattern is described in detail with embodiments below.

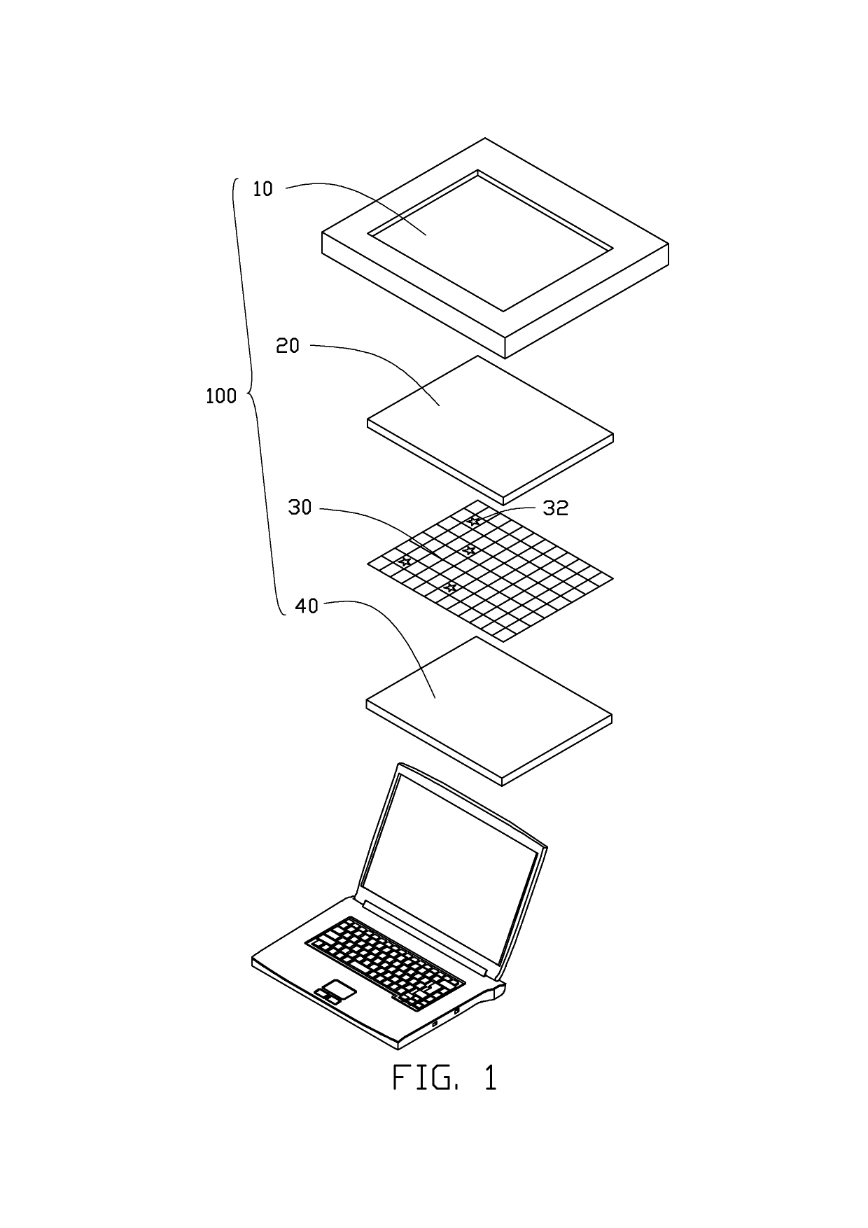

FIG. 1, illustrates an exemplary embodiment of a touch panel 100. The touch panel 100 includes a protective layer 10, a touch display panel 20, a transparent sheet 30, and a backlight panel module 40, which are arranged from top-down. There is a keyboard layout pattern formed on the transparent sheet 30 and the keyboard layout pattern having a plurality of alphanumeric characters 32. The protective layer 10 is used to protect the appearance of the touch panel 100, and also to let the alphanumeric characters 32 of the keyboard layout pattern viewable outside. The protective layer 10 may be made of transparent or translucent silica or plastic materials.

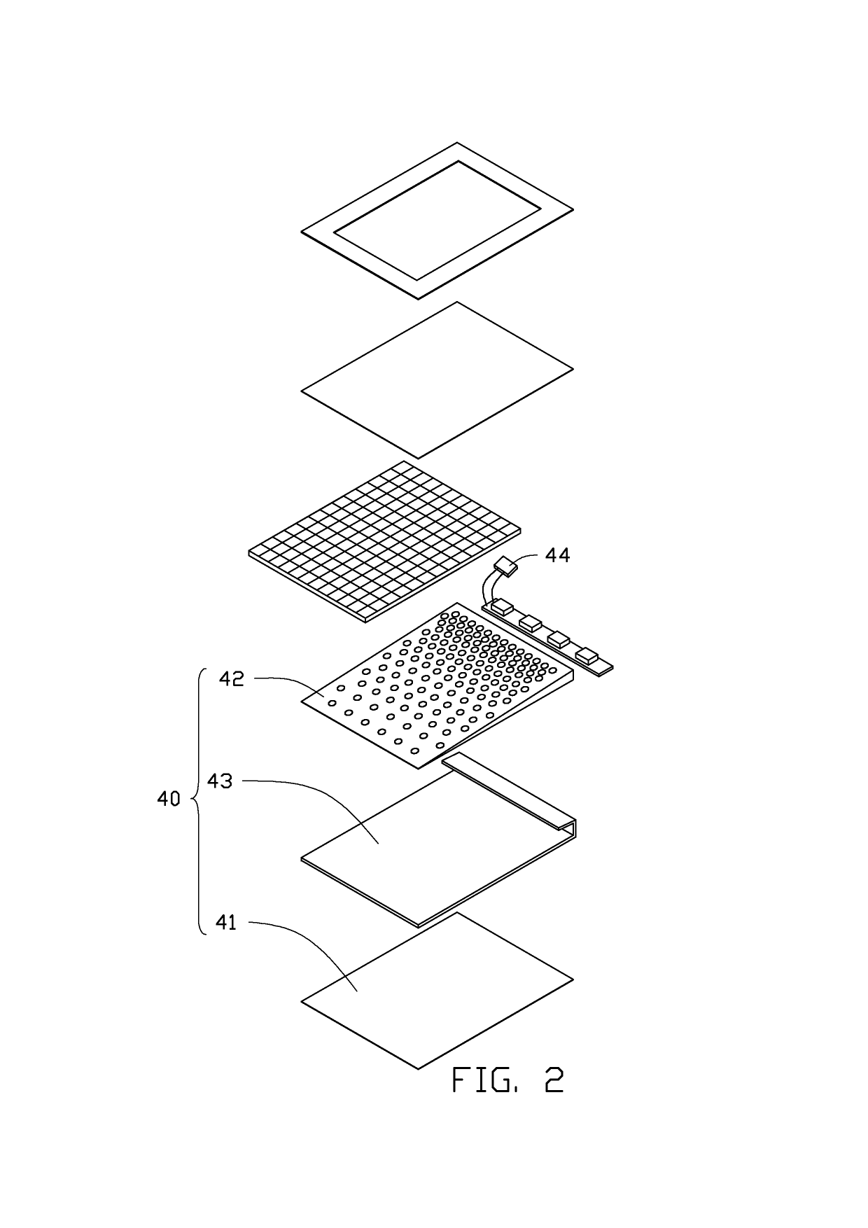

FIG. 2, illustrates an exemplary embodiment of the backlight panel module 40. The backlight panel module 40 is configured for distributing light beams to light the touch panel 100. The backlight panel module 40 includes a reflector 41, a light guide plate 42 and a fixing plastic box 43 which is set between the reflector 41 and the light guide plate 42 to fix the reflector 41 and the light guide plate 42. A plurality of LEDs (light emitting diode) 44 are mounted on one side of the light guide plate 42. The light beams emitted from the LEDs 44 are reflected by the reflector 41 and passed through the light guide plate 42.

The touch display panel 20 is configured for receiving a touch pattern and generating an input signal accordingly. The touch display panel 20 may be made of transparent resistive touch panel, capacitive touch panel or optical touch panel.

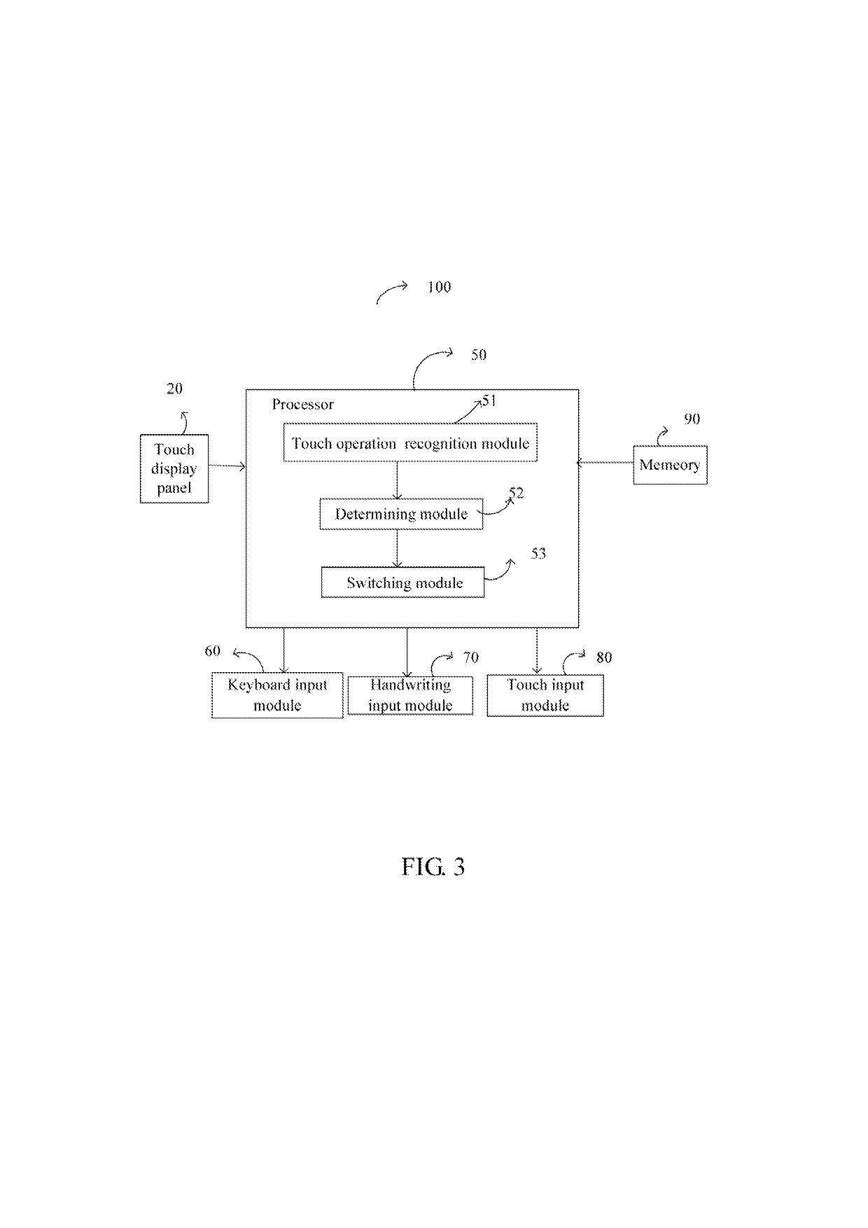

FIG. 3, illustrates an embodiment of the touch panel 100. The touch panel 100 further includes a processor 50 and at least two input modules executed by the processor 50. In the embodiment, the input modules include a keyboard input module 60, a handwriting input module 70 and a touch input module 80. The keyboard input module 60 is configured for allowing a user to input characters by touching the alphanumeric characters 32 appearing on the touch display panel 20. The touch input module 80 is configured for displaying an on-screen keyboard to allow a user to input. In other embodiments, the input modules are two that are chose from the keyboard input module 60, the handwriting input module 70 and the touch input module 80, for example.

The processor 50 includes a touch operation recognition module 51, a determining module 52 and a switching module 53.

The touch operation recognition module 51 is configured for identifying the touch pattern on the touch display panel 20 and sending the identified touch pattern to the determining module 52.

The determining module 52 is configured for comparing the identified touch pattern with preset touch pattern(s) and generating a switching command according to the comparison result and then sending the switching command to the switching module 53. In the embodiment, when the identified touch pattern is the same as the preset touch pattern, the determining module 52 sends a switching command to switching module 53.

The switching module 53 is configured for receiving the switching command from the determining module 52 and activating the corresponding one of the input modules. In the first embodiment, only one touch pattern is defined for switching input modules. In this embodiment, the touch panel 100 switches the input modules by a touch pattern according to a preset switching order. Each time a touch pattern is applied to the touch panel 100 and is identified to be the preset touch pattern to switch input modules, the touch panel 100 switches from the present input module to a sequent input module according to the preset switching order. For example, an exemplary switching order is from keyboard input to handwriting input, further to touch input and last return to keyboard input. Another exemplary switching order is from keyboard input to touch input, further to handwriting input and last return to keyboard input. In the second embodiment, a number of different touch pattern are defined for switching input modules, each touch pattern corresponds to one of the input modules and actives the touch panel 100 to switch to the corresponding input modules.

The following illustrates an input switching method for input methods for the keyboard, in this method, only one touch pattern is pre-defined and the switching order is from keyboard input to handwriting input, further to touch input and last to return to keyboard input.

If the present input method for the touch panel 100 is keyboard input. When user wants to switch the input method, he or she uses his or her figures or a stylus to touch the touch panel 100. The touch pattern recognition module 51 indentifies the touch pattern and sends the identified touch pattern to the determining module 52. If the determining module 52 determines that the identified touch pattern is the same as the pre-defined touch pattern, the determining module 52 sends a switching command to the switching module 53 according to the switching order. The switching module 53 switches off the keyboard input module 60 and switches on the handwriting input module 70 according to the switching command So that, the input method for the touch panel 100 is switched to handwriting input.

If the user inputs a touch pattern, which is the same as the preset touch pattern again, the determining module 52 sends a switching command to the switching module 53 according to the switching order, the switching module 53 switches off the handwriting input module 70 and switches on the touch input module 80. Thereby, the input method for the touch panel 100 is switched to touch input. Therefore, the user can get his desired input method by input preset touch pattern to switch the input methods one by one.

The following illustrates an input switching methods for the input methods for the touch panel 100, in this method, three different touch pattern are pre-defined and each touch pattern corresponds to a particular input method.

If the present input method for the touch panel 100 is keyboard input. When user wants to switch the input method, he or she uses his or hers figures or a stylus to touch the touch panel 100. The touch operation recognition module 51 indentifies the touch pattern and sends the identified touch pattern to the determining module 52. If the determining module 52 determines that the identified touch pattern is the same as one of the pre-defined touch pattern, the determining module 52 sends a switching command to the switching module 53 according to the corresponding input method and the preset touch pattern. The switching module 53 switches off the keyboard input module 60 and switches on the input module corresponding to the touch pattern according to the command. So that, the input method for the touch panel 100 is switched to the desired method.

Moreover, the processor 50 includes a memory 90, which is configured for storing parameters employed to practice the present disclosure, such as one preset touch pattern and the switching order of the input method, or a number of preset touch patterns and the input method corresponding to the touch patterns.

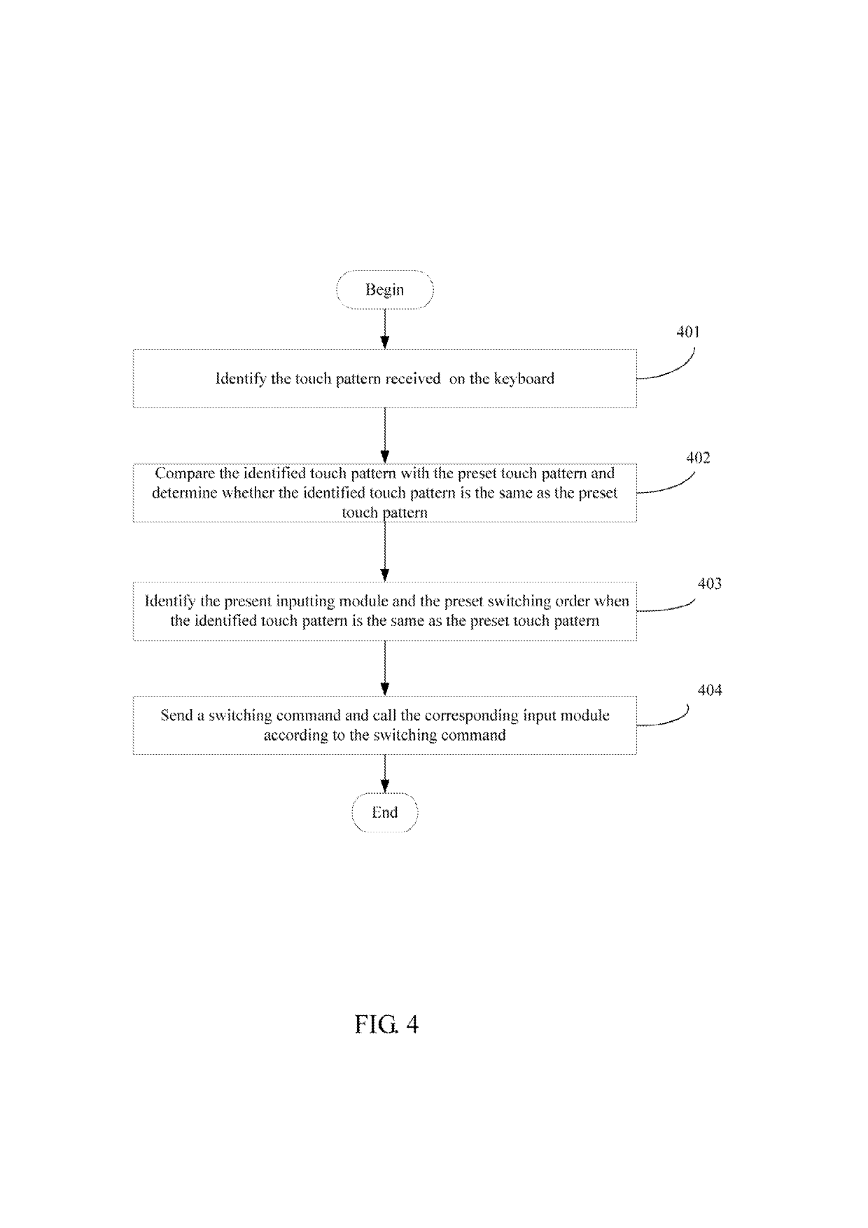

FIG. 4, shows a flowchart of input switching method applied in a keyboard according to a first exemplary embodiment. In the first embodiment, the touch panel 100 includes a keyboard input module, a handwriting input module and a touch input module. Only one touch pattern is preset to be employed to switch the input method according to a preset switching order. The preset switching order is from keyboard input to handwriting input, further to touch input and last return to keyboard input. Alternatively, the preset switching order is from keyboard input to touch input, further to handwriting input and last return to keyboard input.

In step s401, the touch operation recognition module 51 identifies the touch pattern received from a touch operation with figures or stylus on the touch panel 100 and sends the identified touch pattern to the determining module 52. And identifying a touch pattern includes identifying a gesture selected from the group consisting of a one-finger gesture; a two-finger gesture; a continuous gesture; a discontinuous gesture; a sweeping gesture.

In step s402, the determining module 52 compares the identified touch pattern with the preset touch pattern and determines whether the identified touch pattern is the same as the preset touch pattern.

In step s403, the determining module 52 identifies the present input module and the preset switching order when the identified touch pattern is the same as the preset touch pattern.

In step s404, the determining module 52 sends a switching command to the switching module 53 and the switching module 53 calls the corresponding input module according to the switching command Therefore, the touch panel 100 runs the input method of the called input module.

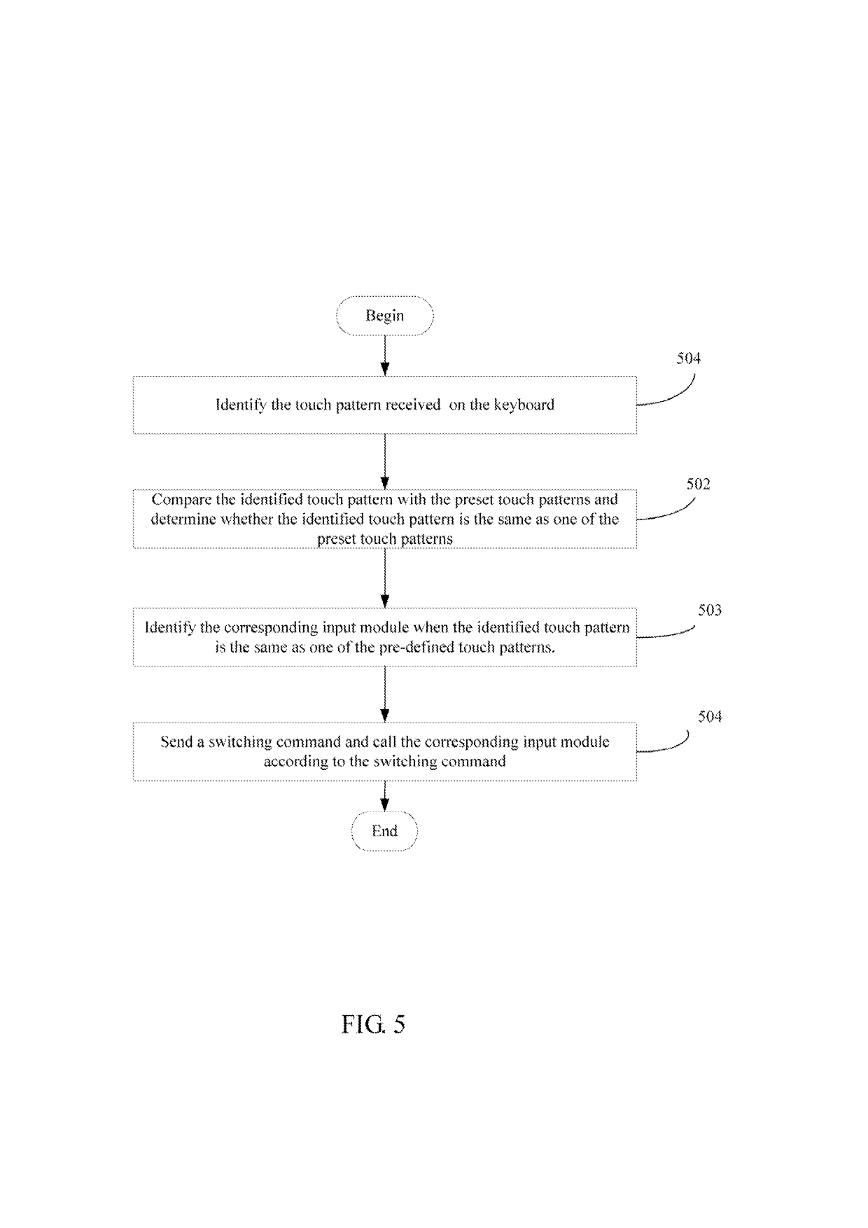

FIG. 5, shows a flowchart of input switching method applied in a keyboard according to a second exemplary embodiment. In the second embodiment, three different touch patterns are per-defined and each touch pattern corresponds to a particular input method.

In step s501, the touch pattern recognition module 51 identifies the touch pattern received from a touch operation with figures or stylus on the touch panel 100 and sends the identified touch pattern to the determining module 52. And identifying a touch pattern includes identifying a gesture selected from the group consisting of a one-finger gesture; a two-finger gesture; a continuous gesture; a discontinuous gesture; a sweeping gesture.

In step s502, the determining module 52 compares the identified touch pattern with the pre-defined touch patterns and determines whether the identified touch pattern is the same as one of the pre-defined touch patterns.

In step s503, the determining module 52 identifies the corresponding input module when the identified touch pattern is the same as one of the pre-defined touch patterns.

In step s504, the determining module 52 sends a switching command to the switching module 53 and the switching module 53 calls the corresponding input module according to the switching command. Therefore, the touch panel 100 runs the input method of the called input module.

The keyboard provided by the present disclosure includes a touch panel to reduce the space and to add the number of input methods to the keyboard. So the keyboard provided by the present disclosure has not only keyboard input method, but also handwriting input method and touch input method. Moreover, the keyboard includes a light module to allow usable in the dark.

The input switching method of the keyboard allows the keyboard to switch the input methods when recognizing the switching touch pattern instead of touching some keys. It is simpler.

Although the present disclosure has been described in considerable detail with reference to certain preferred embodiments thereof, the disclosure is not for limiting the scope of the disclosure. Persons having ordinary skill in the art may make various modifications and changes without departing from the scope and spirit of the disclosure. Therefore, the scope of the appended claims should not be limited to the description of the preferred embodiments described above.

What is claimed is:

1. A touch panel, comprising:
a transparent sheet with a keyboard layout pattern formed thereon, the keyboard layout pattern having a plurality of alphanumeric characters;
a touch display panel;
a backlight panel module, the transparent sheet sandwiched between the touch display panel and the backlight panel module, the keyboard layout pattern being visible through the touch display panel;
at least two input modules chosen from the group consisting of a keyboard input module configured for allowing a user to input characters by touching the alphanumeric characters appearing on the touch display panel, a handwriting input module and a touch input module configured for displaying an on-screen keyboard to allow a user to input;
a processor including:
a touch operation recognition module configured to identify a touch pattern on the touch display panel;
a determining module configured to generate a switching command based upon the identified touch pattern;
a switching module configured to activate the corresponding one of the input modules in response to the switching command.

2. The keyboard as described in claim 1, wherein the processor further includes a memory storing a plurality of parameters corresponding to a plurality of predefined touch patterns and a plurality of switching commands associated with the respective parameters.

3. The keyboard as described in claim 2, wherein the touch operation recognition module is configured to determine a parameter from the identified touch pattern.

4. The keyboard described in claim 3, wherein the determining module is configured to generate the corresponding one of the switching commands if the determined parameter matches with one of the stored parameters.

5. The keyboard as described in claim 2, wherein the switching module is configured to switch the input modules in a predetermined sequence in response to the switching command.

6. The keyboard as described in claim 1, wherein the backlight panel module comprises:
a light guide plate;
a plurality of LEDs mounted on one side of the light guide plate; and
a reflector configured to reflect light beams from the LEDs.

7. An input switching method applied to a keyboard of claim 1, the method comprising:
identifying a touch pattern on the touch display panel;
determining if the identified touch pattern matches with a predefined touch pattern; and
activating the keyboard to enter into a corresponding input mode if the identified touch pattern matches with a predefined touch pattern.

8. The input switching method as described in claim 7, wherein identifying a touch pattern includes identifying a gesture selected from the group consisting of a one-finger gesture; a two-finger gesture; a continuous gesture; a discontinuous gesture; a sweeping gesture.
